(19) United States
(12) Patent Application Publication
(10) Pub. No.: US 2026/0306987 A1
(43) Pub. Date: Oct. 8, 2026

(54) ENVIRONMENTALLY FRIENDLY DUST AND AIRBORNE PARTICULATE ELIMINATION AND CONTROL COMPOSITION AND DISTRIBUTION SYSTEM

(71) Applicants: Nicholas J. Kedrowski, Black River Falls, WI (US); John Heng, Black River Falls, WI (US)

(72) Inventors: Nicholas J. Kedrowski, Black River Falls, WI (US); John Heng, Black River Falls, WI (US)

(21) Appl. No.: 19/170,530

(22) Filed: Apr. 4, 2025

(51) Int. Cl. B01D 47/06

(52) U.S. Cl. CPC B01D 47/06

(57) ABSTRACT

A dust and airborne particulate elimination and control composition is disclosed, including a suitable amount of pine tar, a suitable amount of biodiesel, and a suitable amount of water. The pine tar and biodiesel are combined to form a mixture capable of preventing dust and particulate from becoming airborne.

### TECHNICAL FIELD

The embodiments generally relate to airborne particulate elimination and control products.

### BACKGROUND

Dust control compounds have been used in both indoor and outdoor applications to bind to dust particles and prevent the dust particles from becoming airborne. These same or similar compounds may also be used to actively remove dust particles from the air. In outdoor applications, Calcium Chloride, Magnesium Chloride, water, and combinations of other chemicals are often used. Many of these compounds and chemicals are harmful to the environment. Simply using water is ineffective in dry, hot, arid climates and requires very frequent applications and creates a strain on water supply tables in these regions. Often the application of the chemical control agents only work if the surface if mechanically prepared before application and the volume used must be sufficient to reach a depth of several inches of the soil and the treated area needs to be compacted to secure the loose soil.

### SUMMARY OF THE INVENTION

This summary is provided to introduce a variety of concepts in a simplified form that is further disclosed in the detailed description of the embodiments. This summary is not intended for determining the scope of the claimed subject matter.

A dust and airborne particulate elimination and control composition is disclosed, including a suitable amount of pine tar, a suitable amount of biodiesel and/or vegetable oil, and a suitable amount of water. The pine tar and biodiesel are combined to form a mixture capable of preventing dust and particulate such as ash and other small particulate from becoming airborne.

The composition eliminates the need for surface preparation, reduces water consumption, requires fewer applications compared to using only water, work effectively in hot, dry conditions where water evaporates quickly, and provides adequate dust control without introducing harmful chemicals into the environment. In such, the composition provides an efficient, effective, and ecofriendly means for controlling dust in an application area. This includes retaining particulate matter on a surface as well as removing airborne particulate from the air.

In some aspects, the suitable amount of pine tar is between about 2%-50% by volume.

In some aspects, suitable amount of biodiesel is between about 50%-98% by volume.

In some aspects, the mixture is applied to a surface using a spraying device.

In some aspects, the spraying device applies the mixture to a surface in a uniform diffusion over an application region.

In some aspects, the mixture is environmentally-friendly to reduce the consumption of water.

These and other objects, features, and advantages of the present invention will become more readily apparent from the attached drawings and the detailed description of the preferred embodiments, which follow.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the dust and airborne particular eliminate and control composition being applied using a spraying device mounted to a vehicle, pulled on a trailer or applied with a tanker-style truck according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an environmentally friendly dust and airborne particulate elimination and control composition which can be applied to a surface to prevent particles from becoming airborne as well as bind to airborne particles to remove them from the air. The composition includes environmentally friendly compounds including pine tar and biodiesel which can be mixed with or without water in various amounts depending on the application. The composition may be altered depending on traffic, wind, particulate matter, substrate being treated (i.e., dirt, sand, gravel, etc.), speed of biodegradability, among other factors.

As used herein, the term “biodiesel” may relate to any methyl- or ethyl-ester fatty acid derived from the transesterification of any plant-based oil, cooking oil, and/or animal fats. It is also contemplated that the biodiesel may be made from propanol, butanol, methanol, ethanol, among others. It is to be understood that the biodiesel may be expanded to various colloquial definitions of term, and is not to restricted to the technical definition of a methyl-ester fatty acid derived from soybean oil.

In some embodiments, the composition may include glycerin which may be mixed therein or may replace the use of pine tar in the composition.

In some embodiments, the suitable amount of pine tar is between 2% by volume up to 50% by volume. In such, as little as 2 units of pine tar mixed with 98 units of biodiesel up to as much as 50 units of pine tar mixed with 50 units of biodiesel.

In some embodiments, the suitable amount of biodiesel is between 98% biodiesel by volume to pine tar down to as little as 50% by volume of biodiesel to pine tar. Biodiesel is the primary mixing component of the airborne particulate control.

It is to be understood that the embodiments may utilize biodiesel and/or vegetable oil without deterring from the inventive aspects described herein.

Any amount within the above ranges of the mixture can be sprayed over the desired area to treat without dilution with the mixture ratio being determined by traffic, wind and humidity levels. Heavy traffic areas or areas where heavy equipment is in operation would benefit most from a higher pine tar to biodiesel ratio and areas of light traffic can be treated with a lower ratio of pine tar to biodiesel mixture.

The mixture can be diluted with water to extend coverage in lower traffic areas where dilution with water to create a mixture as little as 1 part dust control to 100 parts water. In addition to water dilution, the dust control mixture can be modified from the above formula to include the addition of glycerin to reduce or offset the amount of pine tar used. When glycerin is included in the formula, it can replace up to 50% of the appropriate pine tar used in the mixture by volume. If you normally use 10 units of pine tar and 100 units of biodiesel, you may reduce the pine tar to 5 units of pine tar, add 5 units of glycerin to the 100 units of biodiesel. Glycerin substitution should not exceed 50% of the pine tar amount by volume.

Glycerin is utilized for its hygroscopic properties which enhance the compositions dust control properties. Glycerin also provides the benefit of being easily digested by microorganisms to enhance biodegradation.

The full range of the mixture can be sprayed over the desired area to treat without dilution with the mixture ratio being determined by traffic, wind and humidity levels. Heavy traffic areas or areas where heavy equipment is in operation would benefit most from a higher pine tar to biodiesel ratio and areas of light traffic can be treated with a lower ratio of pine tar to biodiesel mixture. The application of the dust control mixture can be used in any suitable ratio in place of water or can be mixed with water to improve the duration of the dust and particulate reduction in applications where water alone is being used to treat the areas. The effective dilution ratio for dust control to water will vary depending on the factors noted in claim 4 and can be a little as 98% water to dust control to as much as no dilution of the suitable amount.

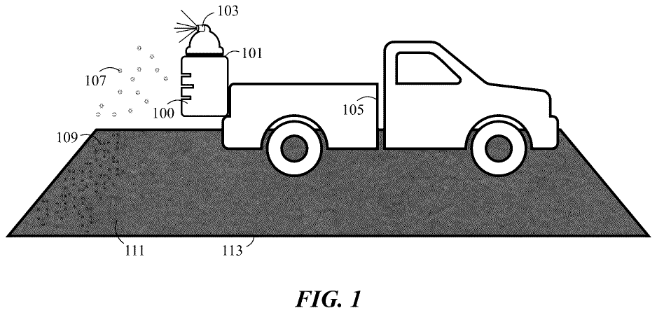

As is shown in FIG. 1, the composition (i.e., the mixture) 100 can be loaded into a container 101 having a spraying device 103. The container 101 and spraying device 103 can be mounted to a vehicle 105 such that the application of the composition can be easily spread over the desired area. The container 101 and spraying device 103 may also be handheld and easily portable or mounted to other carrying devices such as a hand cart, a trailer etc., and even distributed in large volumes by a tanker style truck. It is also contemplated that the container 101 includes wheels to allow it to be easily transported during the application process, to and from the application site, etc. The spraying device 103 emits the composition to remove airborne particles 107 from the air, as well as retain surface particles 109 on a surface 111 of the application site 113.

The composition eliminates the need for surface preparation, reduces water consumption, requires fewer applications compared to using only water, work effectively in hot, dry conditions where water evaporates quickly, and provides adequate dust control without introducing harmful chemicals into the environment.

The composition is dilutable in water and may include between 0.1% and 98% water depending on various application site parameters (e.g., traffic, particulate matter present at the application site, climate conditions, environmental factors, and water consumption restrictions, among others). The composition may be applied in a non-diluted form, wherein no water is mixed into the composition.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A dust and airborne particulate elimination and control composition, comprising:
a suitable amount of pine tar;
a suitable amount of biodiesel; and
a suitable amount of water, wherein the suitable amount of pine tar and the suitable amount of biodiesel to form a mixture capable of preventing dust and particulate from becoming airborne.

2. The composition of claim 1, wherein the suitable amount of pine tar is between about 2%-50% by volume.

3. The composition of claim 1, wherein the suitable amount of biodiesel is between about 50%-98% by volume.

4. The composition of claim 1, wherein the mixture is applied to a surface using a spraying device.

5. The composition of claim 4, wherein the spraying device applies the mixture to a surface in a uniform diffusion over an application region.

6. The composition of claim 1, wherein the mixture is environmentally-friendly to reduce the consumption of water.

7. A dust and airborne particulate elimination and control composition, comprising:
a suitable amount of pine tar and a suitable amount of biodiesel each added to water to form a mixture;
a container to store the mixture; and
a spraying device in fluid communication with the container, the distribution device to enable application of the mixture over an application region to prevent dust and particulate from becoming airborne.

8. The composition of claim 7, wherein the suitable amount of pine tar is between about 2%-50% by volume.

9. The composition of claim 8, wherein the suitable amount of biodiesel is between about 50%-98% by volume.

10. The composition of claim 9, wherein the mixture is applied to a surface using a spraying device.

11. The composition of claim 10, wherein the spraying device is portable.

12. The composition of claim 10, wherein the spraying device is mounted to a vehicle.

13. The composition of claim 10, wherein the mixture is environmentally-friendly to reduce the consumption of water.

14. A dust and airborne particulate elimination and control composition, comprising:
a composition comprising between about 2%-50% by volume of pine tar and a between about 50%-98% by volume of biodiesel to form a mixture;
a container to store the mixture;
a spraying device in fluid communication with the container, the distribution device to enable application of the mixture over an application region to prevent dust and particulate from becoming airborne, wherein the container is mounted to a vehicle.

15. The system of claim 14, wherein the composition is diluted with a suitable amount of water.

16. The system of claim 15, wherein the suitable amount of water is between about 0.01%-98% water.

17. The system of claim 16, wherein the suitable amount of water is selected based on one or more application site parameters.

18. The system of claim 15, wherein the composition is comprised of a suitable amount of glycerin and a suitable amount of biodiesel.
